(19) United States
(12) Patent Application Publication
(10) Pub. No.: US 2023/0411685 A1
(43) Pub. Date: Dec. 21, 2023

(54) ELECTROLYTE FILM WITH LOW INTERFACIAL RESISTANCE

(71) Applicant: GM GLOBAL TECHNOLOGY OPERATIONS LLC, Detroit, MI (US)

(72) Inventors: Qili SU, Shanghai (CN); Zhi LI, Shanghai (CN); Dewen KONG, Shanghai (CN); Haijing LIU, Shanghai (CN)

(73) Assignee: GM GLOBAL TECHNOLOGY OPERATIONS LLC, Detroit, MI (US)

(21) Appl. No.: 17/901,279

(22) Filed: Sep. 1, 2022

(30) Foreign Application Priority Data
Jun. 21, 2022 (CN) 202210704113.4

(51) Int. Cl. H01M 10/0565

(52) U.S. Cl. CPC H01M 10/0565; H01M 2300/0085

(57) ABSTRACT

The present disclosure provides an electrolyte layer for use in an electrochemical cell that cycles lithium ions. The electrolyte layer includes a porous film that defines a plurality of voids and includes a plurality of solid-state electrolyte particles and a plurality of polymeric fibrils that connect the solid-state electrolyte particles. The electrolyte layer also includes a gel polymeric electrolyte that at least partially fills the plurality of voids in the porous film. The porous film has a thickness greater than or equal to about 2 micrometers to less than or equal to about 100 micrometers, and a porosity greater than or equal to about 10 vol. % to less than or equal to about 50 vol. %. The a gel polymeric electrolyte fills greater than or equal to about 0.1% to less than or equal to about 150% of a total porosity of the porous film.

### CROSS-REFERENCE TO RELATED APPLICATIONS

This application claims the benefit and priority of Chinese Application No. 202210704113.4 filed Jun. 21, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“OAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery.

A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required. Solid-state electrolytes, like oxide-base solid-state electrolyte layers often have larger thicknesses (e.g., 600), decreasing the overall energy density of the battery. Such solid-state electrolytes are also often suited only for use at low currents (e.g., 0.05 C-rate) and comparatively high temperatures (e.g., 60° C.). Accordingly, it would be desirable to develop electrolyte layers having improved energy densities and conductivities, as well as mechanical properties.

### SUMMARY

This section provides a general summary of the disclosure, and is not a comprehensive disclosure of its full scope or all of its features.

The present disclosure relates to electrolyte layers for electrochemical cells that cycle lithium ions, and methods of making and using the same. The electrolyte layers are, for example, oxide-based solid-state electrolyte layers, including fibrillated polymers and a gel polymer electrolyte.

In various aspects, the present disclosure provides an electrolyte layer for use in an electrochemical cell that cycles lithium ions. The electrolyte layer may include a porous film that defines a plurality of voids and includes a plurality of solid-state electrolyte particles and a plurality of polymeric fibrils that connect the solid-state electrolyte particles. The electrolyte layer also includes a gel polymeric electrolyte that may at least partially fills the plurality of voids in the porous film.

In one aspect, the solid-state electrolyte particles may have an ionic conductivity greater than or equal to about 0.1 mS/cm to less than or equal to about 20 mS/cm at greater than or equal to about 20° C. to less than or equal to about 22° C. The plurality of solid-state electrolyte particles may be selected from the group consisting of: oxide-based solid-state particles, metal-doped or aliovalent-substituted oxide solid-state particles, halide-based solid-state particles, hydride-based solid-state particles, and combinations thereof.

In one aspect, the plurality of solid-state electrolyte particles may include oxide-based solid-state particles.

In one aspect, the polymeric fibrils may be selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

In one aspect, the polytetrafluorethylene (PTFE) fibrils may have a softening point of greater than or equal to about 260° C. to less than or equal to about 327° C. The fluorinated ethylene propylene (FEP) fibrils may have a softening point greater than or equal to about 204° C. to less than or equal to about 260° C. The ethylene tetrafluoroethylene (ETFE) fibrils may have a softening point greater than or equal to about 260° C. to less than or equal to about 315° C.

In one aspect, each of the polymeric fibrils may have a fiber length greater than or equal to about 2 micrometers to less than or equal to about 100 micrometers and a molecular weight greater than or equal to about 10⁵ g/mol to less than or equal to about 10⁹ g/mol.

In one aspect, the gel polymeric electrolyte may include greater than or equal to about 0.1 wt. % to less than or equal to about 50 wt. % of a polymer host, and greater than or equal to about 5 wt. % to less than or equal to about 90 wt. % of a liquid electrolyte.

In one aspect, the polymer host may be selected from the group consisting of: polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

In one aspect, the porous film may have a porosity greater than or equal to about 10 vol. % to less than or equal to about 50 vol. %, and the gel polymer electrolyte may fill greater than or equal to about 0.1% to less than or equal to about 150% of a total porosity defined by the plurality of voids of the porous film.

In one aspect, the porous film may include greater than or equal to about 70 wt. % to less than or equal to about 99 wt. % of the plurality of solid-state electrolyte particles, greater than or equal to about 0.1 wt. % to less than or equal to about 10 wt. % of the plurality of polymeric fibrils, and greater than or equal to about 0.1 wt. % to less than or equal to about 20 wt. % of the gel polymeric electrolyte.

In one aspect, the electrolyte layer may have an average thickness greater than or equal to about 2 micrometers to less than or equal to about 100 micrometers.

In various aspects, the present disclosure provides an electrochemical cell that cycles lithium ions. The electrochemical cell may include a first electrode, a second electrode, and an electrolyte layer disposed between the first electrode and the second electrode. The electrolyte layer may include a plurality of solid-state electrolyte particles, a plurality of polymeric fibrils that connect the solid-state electrolyte particles, and a gel polymeric electrolyte that at least partially fills voids defined between the solid-state electrolyte particles and the polymeric fibrils.

In one aspect, the plurality of solid-state electrolyte particles may have an ionic conductivity greater than or equal to about 0.1 mS/cm to less than or equal to about 20 mS/cm at greater than or equal to about 20° C. to less than or equal to about 22° C. The plurality of solid-state electrolyte particles may be selected from the group consisting of: oxide-based solid-state particles, metal-doped or aliovalent-substituted oxide solid-state particles, halide-based solid-state particles, hydride-based solid-state particles, and combinations thereof.

In one aspect, each of the polymeric fibrils may have a fiber length greater than or equal to about 2 micrometers to less than or equal to about 100 micrometers and a molecular weight greater than or equal to about 10⁵ g/mol to less than or equal to about 10⁹ g/mol. The polymeric fibrils may be selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

In one aspect, the gel polymeric electrolyte may include greater than or equal to about 0.1 wt. % to less than or equal to about 50 wt. % of a polymer host, and greater than or equal to about 5 wt. % to less than or equal to about 90 wt. % of a liquid electrolyte.

In one aspect, the plurality of solid-state electrolyte particles and the plurality of polymeric fibrils that connect the solid-state electrolyte particles may define a porous film that defines a plurality of voids. The porous film may have a porosity greater than or equal to about 10 vol. % to less than or equal to about 50 vol. %, and the gel polymeric electrolyte may fill greater than or equal to about 0.1% to less than or equal to about 150% of the plurality of voids in the porous film.

In one aspect, the electrolyte layer may have a thickness greater than or equal to about 2 micrometers to less than or equal to about 100 micrometers.

In various aspects, the present disclosure may provide an electrolyte layer for use in an electrochemical cell that cycles lithium ions. The electrolyte layer may include a porous film defined by a plurality of oxide-based solid-state particles and a plurality of polymeric fibrils that connect the solid-state electrolyte particles. The porous film may have a thickness greater than or equal to about 2 micrometers to less than or equal to about 100 micrometers, and a porosity greater than or equal to about 10 vol. % to less than or equal to about 50 vol. %. The electrolyte layer may further include a gel polymeric electrolyte that fills greater than or equal to about 0.1% to less than or equal to about 150% of a total porosity of the porous film.

In one aspect, each of the polymeric fibrils may have a fiber length greater than or equal to about 2 micrometers to less than or equal to about 100 micrometers. The polymeric fibrils may be selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

In on aspect, the gel polymeric electrolyte may include greater than or equal to about 0.1 wt. % to less than or equal to about 50 wt. % of a polymer host, and greater than or equal to about 5 wt. % to less than or equal to about 90 wt. % of a liquid electrolyte.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of

selected embodiments and not all possible implementations, and are not intended to limit the scope of the present disclosure.

FIG. 1 is an illustration of an example electrochemical cell including an electrolyte layer including a plurality of solid-state electrolyte particles, fibrillated polymers, and a gel polymer electrolyte in accordance with various aspects of the present disclosure;

FIG. 2 is a flowchart illustrating an example method for forming an electrolyte layer in accordance with various aspects of the present disclosure;

FIG. 3A is a graphical illustration demonstrating the impedance of an example electrolyte layer in accordance with various aspects of the present disclosure;

FIG. 3B is a graphical illustration demonstrating the capacity retention of an example electrolyte layer in accordance with various aspects of the present disclosure; and

FIG. 3C is a graphical illustration demonstrating area conductance (ohms/cm²) of an example electrolyte layer in accordance with various aspects of the present disclosure.

Corresponding reference numerals indicate corresponding parts throughout the several views of the drawings.

### DETAILED DESCRIPTION

Example embodiments are provided so that this disclosure will be

thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

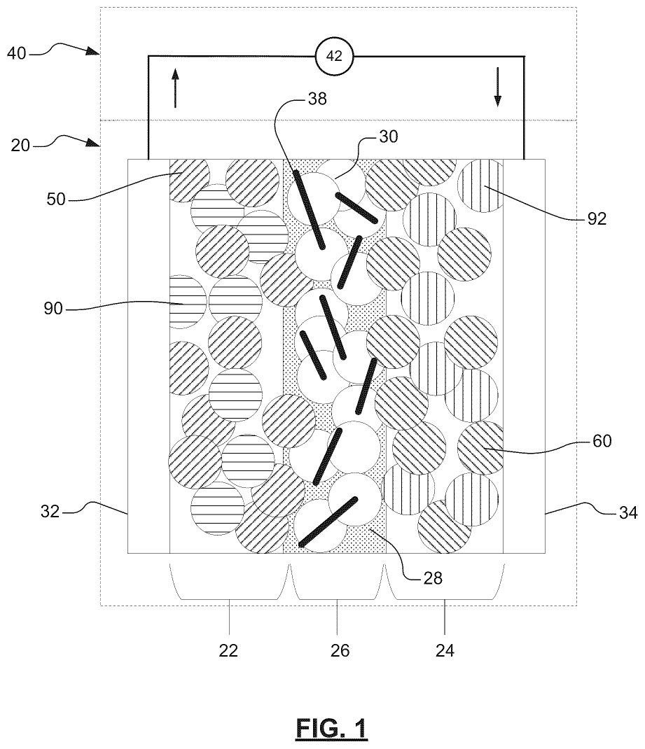

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes 22, 24. The electrolyte layer 26 is a solid-state or semi-solid state separating layer that physically separates the negative electrode 22 from the positive electrode 24. As further discussed below, the electrolyte layer 26 may include a flexible, porous film defined by a first plurality of solid-state electrolyte particles 30 and fibrillated polymers 38, and a (first) gel polymer electrolyte 28 that at least partially fills voids or pores and grain boundaries in the porous film.

A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, which may together with the first plurality of electrolyte layer 30 form a continuous electrolyte network. Further, although not illustrated, it should be recognized that in certain variations, a (second) gel polymer electrolyte may also be included in the negative electrode 22 that at least partially fills voids between the negative solid-state electroactive particles 50 and/or the optional second plurality of solid-state electrolyte particles 90. Similarly, a (third) gel polymer electrolyte may be included in the positive electrode 24 that at least partially fills voids between the positive solid-state electroactive particles 60 and/or the optional third plurality of solid-state electrolyte particles 92. The second gel polymer electrolyte may be the same as or different from the third gel polymer electrolyte. The second gel polymer electrolyte and/or third gel polymer electrolyte may be the same as or different from the first gel polymer electrolyte.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be cladded foils, for example, where one side (e.g., the first side or the second side) of the current collector 32, 34 includes one metal (e.g., first metal) and another side (e.g., the other side of the first side or the second side) of the current collector 32 includes another metal (e.g., second metal). In certain variations, the cladded foils may include, for example only, aluminum-copper (Al—Cu), nickel-copper (Ni—Cu), stainless steel-copper (SS—Cu), aluminum-nickel (Al—Ni), aluminum-stainless steel (Al-SS), and nickel-stainless steel (Ni-SS). In certain variations, the first bipolar current collector 32 and/or second bipolar current collectors 34 may be pre-coated including, for example, graphene or carbon-coated aluminum current collectors.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular application for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the electrolyte layer 26 provides electrical separation—preventing physical contact—between the negative electrode 22 and the positive electrode 24. The electrolyte layer 26 also provides a minimal resistance path for internal passage of lithium ions. In certain variations, the electrolyte layer 26 may be a free-standing membrane having. That is, the electrolyte layer 26 may be self-supporting with structural integrity and may be handled as an independent layer (e.g., removed from a substrate) rather than a coating formed on another component.

In various aspects, the electrolyte layer 26 may include a porous film defined by a first plurality of solid-state electrolyte particles 30 and fibrillated polymers 38. For example, the fibrillated polymers 38 may effectively connect or adhere together the solid-state electrolyte particles 30. The porous film may have a porosity greater than or equal to about 10 vol. % to less than or equal to about 50 vol. %, and in certain aspects, optionally greater than or equal to about 25 vol. % to less than or equal to about 40 vol. %. The electrolyte layer 26 further includes a (first) gel polymer electrolyte 28 that at least partially fills pores in the porous film. For example, the gel polymer electrolyte 28 may permeate voids and/or grain boundaries between the solid-state electrolyte particles 30 helping to build favorable ion transfer bridges at the solid-solid interfaces. In certain variations, the gel polymer electrolyte 28 may fill greater than or equal to about 0.1% to less than or equal to about 150%, and in certain aspects, optionally greater than or equal to about 60% to less than or equal to about 100%, of a total porosity of the porous film.

In various aspects, the solid-state electrolyte particles 30 are selected so as to have a high ionic conductivity. For example, the solid-state electrolyte particles 30 may have an ionic conductivity greater than or equal to about 0.1 mS/cm to less than or equal to about 20 mS/cm, and in certain aspects, optionally greater than or equal to about 0.1 mS/cm to less than or equal to about 5 mS/cm, at room temperature (i.e. greater than or equal to about 20° C. to less than or equal to about 22° C.). In certain variations, the solid-state electrolyte particles 30 may have an average particle diameter greater than or equal to about 0.02 μm to less than or equal to about 20 μm, optionally greater than or equal to about 0.1 μm to less than or equal to about 10μm, and in certain aspects, optionally greater than or equal to about 0.1 μm to less than or equal to about 1 μm.

In certain variations, the solid-state electrolyte particles 30 may include, for example, oxide-based solid-state particles. The oxide-based solid-state particles may include garnet type solid-state particles (e.g., Li₇La₃Zr₂O₁₂), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1). In other variations, the solid-state electrolyte particles 30 may include, for example, metal-doped or aliovalent-substituted oxide solid-state particles. The metal-doped or aliovalent-substituted oxide solid-state particles may include aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{y}P_{3-y}O₁₂ (where 0<x<2 and 0<y<3). In further variations, the solid-state electrolyte particles 30 may include, for example, halide-based solid-state particles. The halide-based solid-state particles may include Li₃YCl₆, Li₃InCl₆, Li₃YBr₆, LiI, Li₂CdC₁₄, Li₂MgCl₄, LiCdI₄, Li₂ZnI₄, Li₃OCl, and combinations thereof. In still other variations, the solid-sate electrolyte particles 30 may include, for example, hydride-based solid-state particles. The hydride-based solid-state particles may include LiBH₄, LiBH₄—LiX (where x=Cl, Br, or I), LiNH₂, Li₂NH, LiBH₄—LiNH₂, Li₃AlH₆, and combinations thereof. In still further variations, the solid-state electrolyte particles 30 may include a combination of oxide-based solid-state particles, metal-doped or aliovalent-substituted oxide solid-state particles, halide-based solid-state particles, hydride-based solid-state particles, and/or other low grain-boundary resistance solid-state electrolyte particles.

The fibrillated polymers 38 provides a structural framework for the solid-state electrolyte particles 30. For example, the fibrillated polymers 38 may span between, and in certain variations, connect, the solid-state electrolyte particles 30. In certain variations, the fibrillated polymers 38 may include polytetrafluorethylene (PTFE) fibrils. The polytetrafluorethylene (PTFE) fibrils may have an average length of greater than or equal to about 2 micrometers (μm) to less than or equal to about 100 μm, a softening point of greater than or equal to about 260° C. to less than or equal to about 327° C., and a molecular weight greater than or equal to about 10⁵ g/mol to less than or equal to about 10⁹ g/mol. In other variations, the fibrillated polymers 38 may include fluorinated ethylene propylene (FEP) fibrils having an average length of greater than or equal to about 2 μm to less than or equal to about 100 μm, a softening point of greater than or equal to about 204° C. to less than or equal to about 260° C., and a molecular weight greater than or equal to about 10⁵ g/mol to less than or equal to about 10⁹ g/mol. In further variations, the fibrillated polymers 38 may include perfluoroalkoxy alkane (PFA) fibrils having an average length of greater than or equal to about 2 μm to less than or equal to about 100 μm, a softening point of greater than or equal to about 260° C. to less than or equal to about 315° C., and a molecular weight greater than or equal to about 10⁵ g/mol to less than or equal to about 10⁹ g/mol. In still other variations, the fibrillated polymers 38 may include ethylene tetrafluoroethylene (ETFE) fibrils having an average length of greater than or equal to about 2 μm to less than or equal to about 100 μm, a softening point of greater than or equal to about 120° C. to less than or equal to about 265° C., and a molecular weight greater than or equal to about 10⁵ g/mol to less than or equal to about 10⁹ g/mol. In still further variations, the fibrillated polymers 38 may include a combination of polytetrafluorethylene (PTFE) fibrils, fluorinated ethylene propylene (FEP) fibrils, perfluoroalkoxy alkane (PFA) fibrils, and/or ethylene tetrafluoroethylene (ETFE) fibrils. As discussed in further detail below, the fibrillated polymers 38 may be prepared by using a dispersion process where a precursor material (e.g., polytetrafluorethylene (PTFE) binder) has average particle size greater than or equal to about 1 μm to less than or equal to about 2,000 μm, optionally greater than or equal to about 1 μm to less than or equal to about 1,000 μm, and in certain aspects, optionally greater than or equal to about 400 μm to less than or equal to about 700 μm.

The gel polymer electrolyte 28 includes a polymer host and a liquid electrolyte. For example, the gel polymer electrolyte 28 may include greater than or equal to about 0.1 wt. % to less than or equal to about 50 wt. %, and in certain aspects, optionally greater than or equal to about 2 wt. % to less than or equal to about 30 wt. %, of the polymer host; and greater than or equal to about 5 wt. % to less than or equal to about 90 wt. %, and in certain aspects, optionally greater than or equal to about 50 wt. % to less than or equal to about 80 wt. %, of the liquid electrolyte. In certain variations, the polymer host may be selected from the group consisting of: polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

The liquid electrolyte includes, for example, greater than or equal to about 5 wt. % to less than or equal to about 70 wt. %, and in certain aspects, optionally greater than or equal to about 10 wt. % to less than or equal to about 50 wt. %, of a lithium salt, and greater than or equal to about 30 wt. % to less than or equal to about 95 wt. %, and in certain aspects, optionally greater than or equal to about 50 wt. % to less than or equal to about 90 wt. %, of a solvent. The lithium salt includes a lithium cation (Li⁺) and an anion selected from the group consisting of: hexafluoroarsenate, hexafluorophosphate, bis(fluorosulfonyl)imide (FSI⁻), perchlorate, tetrafluoroborate, cyclo-difluoromethane-1,1-bis(sulfonyl)imide (DMSI), bis(trifluoromethanesulfonyl)imide (TFSI), bis(perfloroethanesulfonyl)imide (BETI), bis(oxalate)boarate (BOB), difluoro(oxalato)borate (DFOB), bis(fluoromalonato)borate (BFMB), and combinations thereof.

The solvent dissolves the lithium salt to enable good lithium ion conductivity, while also exhibiting a low vapor pressure (e.g., less than about 10 mmHg at 25° C.) to match the cell fabrication process. In various aspects, the solvent includes, for example, carbonate solvents (such as, ethylene carbonate (EC), propylene carbonate (PC), glycerol carbonate, vinylene carbonate, fluoroethylene carbonate, 1,2-butylene carbonate, and the like), lactones (such as, y-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), phosphates (such as, triethyl phosphate, trimethyl phosphate, and the like), ionic liquids including, for example, ionic liquid cations (such as, 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as, bis(trifluoromethanesulfonyl)imide (TFSI), bis(fluorosulfonyl imide (FS), and the like), and combinations thereof.

The electrolyte layer 26 may be in the form of a layer having an average thickness greater than or equal to about 2 μm to less than or equal to about 100 μm, optionally greater than or equal to about 20 μm to less than or equal to about 60 μm, and in certain aspects, optionally about 50 μm. The electrolyte layer 26 may include greater than or equal to about 70 wt. % to less than or equal to about 99 wt. %, and in certain aspects, optionally greater than or equal to about 80 wt. % to less than or equal to about 90 wt. %, of the solid-state electrolyte particles 30; greater than or equal to about 0.1 wt. % to less than or equal to about 10 wt. %, and in certain aspects, optionally greater than or equal to about 0.1 wt. % to less than or equal to about 3 wt. %, of the fibrillated polymers 38; and greater than or equal to about 0.1 wt. % to less than or equal to about 20 wt. %, and in certain aspects, optionally greater than or equal to about 0.1 wt. % to less than or equal to about 15 wt. %, of the gel polymer electrolyte.

With renewed reference to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50, and greater than or equal to 0 wt. % to less than or equal to about 50 wt. %, and in certain aspects, optionally greater than or equal to about 5 wt. % to less than or equal to about 20 wt. %, of the second plurality of solid-state electrolyte particles 90. In each variation, the negative electrode 22 may be in the form of a layer having an average thickness greater than or equal to about 10 μm to less than or equal to about 5,000 μm, and in certain aspects, optionally greater than or equal to about 10 μm to less than or equal to about 100 μm.

The negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; and/or metal sulfides, such as FeS. The negative solid-state electroactive particles 50 may be selected from the group including, for example only, lithium, graphite, graphene, hard carbon, soft carbon, carbon nanotubes, silicon, silicon-containing alloys, tin-containing alloys, and/or other lithium-accepting materials.

The second plurality of solid-state electrolyte particles 90 may be the same as or different from the first plurality of solid-state electrolyte particles 30. For example, the second plurality of solid-state electrolyte particles 90 may include oxide-based solid-state particles, metal-doped or aliovalent-substituted oxide solid-state particles, halide-based solid-state particles, hydride-based solid-state particles, and/or other low grain-boundary resistance solid-state electrolyte particles.

Although not illustrated, in certain variations, the negative electrode 22 may further include one or more conductive additives and/or binder materials. The negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22. For example, the negative electrode may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The negative solid-state electroactive particles 50 (and/or second plurality of solid-state electrolyte particles 90) may be optionally intermingled with binders, such as sodium carboxymethyl cellulose (CMC), styrene ethylene butylene styrene copolymer (SEBS), styrene butadiene styrene copolymer (SBS), polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60, and greater than or equal to 0 wt. % to less than or equal to about 50 wt. %, and in certain aspects, optionally greater than or equal to about 5 wt. % to less than or equal to about 20 wt. %, of the third plurality of solid-state electrolyte particles 92. In each variation, the positive electrode 24 may be in the form of a layer having an average thickness greater than or equal to about 10 μm to less than or equal to about 5,000 μm, and in certain aspects, optionally greater than or equal to about 10 μm to less than or equal to about 100 μm.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. The positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

The third plurality of solid-state electrolyte particles 92 may be the same as or different from the first and/or second pluralities of solid-state electrolyte particles 30, 90. For example, the third plurality of solid-state electrolyte particles 92 may include oxide-based solid-state particles, metal-doped or aliovalent-substituted oxide solid-state particles, halide-based solid-state particles, hydride-based solid-state particles, and/or other low grain-boundary resistance solid-state electrolyte particles.

Although not illustrated, in certain variations, the positive electrode 24 may further include one or more conductive additives and/or binder materials. The positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24. For example, the positive electrode 24 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders.

The one or more conductive materials optionally intermingled with the positive solid-state electroactive particles 60 (and/or third plurality of solid-state electrolyte particles 92) may be the same as or different from the one or more conductive materials optionally intermingled with the negative solid-state electroactive particles 50 (and/or second plurality of solid-state electrolyte particles 90). The one or more binders optionally intermingled with the positive solid-state electroactive particles 60 (and/or third plurality of solid-state electrolyte particles 92) may be the same as or different from the one or more binders optionally intermingled with the negative solid-state electroactive particles 50 (and/or second plurality of solid-state electrolyte particles 90).

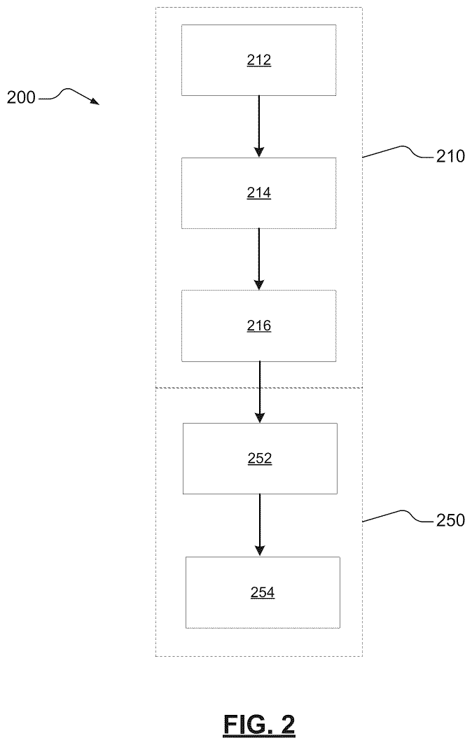

In various aspects, the present disclosure provides methods for fabricating electrolyte layers including a porous film defined by plurality of solid-state electrolyte particles and fibrillated polymers, and a gel polymer electrolyte that at least partially fills pores in the porous film. For example, FIG. 2 illustrates an example method 200 for forming an example electrolyte layer, like the electrolyte layer 26 illustrated in FIG. 1. As illustrated, the method 200 includes forming 210 a free-standing porous film and loading 250 the free-standing porous film with a gel polymer electrolyte. In certain variations, the forming 210 may include contacting 212 a plurality of solid-state electrolyte particles and one or more polymers capable of forming fibers, for example, fibrillate in the presence of compressive shearing forces. The one or more polymers may include, for example, polytetrafluorethylene (PTFE), fluorinated ethylene propylene (FEP), perfluoroalkoxy alkane (PFA), and/or ethylene tetrafluoroethylene (ETFE). The solid-state electrolyte particles may include oxide-based solid-state particles, metal-doped or aliovalent-substituted oxide solid-state particles, halide-based solid-state particles, hydride-based solid-state particles, and/or other low grain-boundary resistance solid-state electrolyte particles.

In certain variations, the contacting 212 may include forming an admixture and mixing the admixture to form a powder including the plurality of solid-state electrolyte particles and a plurality of polymer fibers connecting or adhering the solid-state electrolyte particles. The admixture may further include a processing solvent, such as ethanol, isopropanol, and/or water. For example, the admixture may include greater than or equal to about 50 wt. % to less than or equal to about 80 wt. % of the solid-state electrolyte particles, greater than or equal to about 0.01 wt. % to less than or equal to about 10 wt. % of the polymers capable of forming fibers, and greater than or equal to about 0 wt. % to less than or equal to about 30 wt. % of the processing solvent. The forming 210 may further includes preparing a precursor film 214 (for example, using a forming machine having a powder feeder) and calendaring 216 the precursor film to form the free-standing porous film. Although not illustrated, in certain variations, the method 200 may also including one or more drying or heating steps prior to, or following, the calendaring 216. In each instance, the free-standing porous film may have an average thickness greater than or equal to about 2 μm to less than or equal to about 100 μm and a porosity greater than or equal to about 20 vol. % to less than or equal to about 50 vol. %.

Loading 250 the free-standing porous film with a gel polymer electrolyte may include contacting 252 the free-standing porous film with a gel precursor solution such that the gel precursor solution permeates voids or pores and grain boundaries between the solid-state electrolyte particles and the polymer fibers. In certain variations, the contacting 252 may include immerging the free-standing porous film in a bath including the gel precursor solution using a roll-to-roll process. The gel precursor solution includes a polymer host, a liquid electrolyte, and an additional solvent. For example, the gel precursor may include greater than or equal to about 2 wt. % to less than or equal to about 20 wt. % of the polymer host, greater than or equal to about 30 wt. % to less than or equal to about 70 wt. % of the liquid electrolyte, and greater than or equal to about 10 wt. % to less than or equal to about 50 wt. % of the additional solvent.

As detailed above, the polymer host may be selected from the group consisting of: polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof and the liquid electrolyte may include greater than or equal to about 5 wt. % to less than or equal to about 70 wt. %, and in certain aspects, optionally greater than or equal to about 10 wt. % to less than or equal to about 50 wt. %, of a lithium salt, and greater than or equal to about 30 wt. % to less than or equal to about 95 wt. %, and in certain aspects, optionally greater than or equal to about 50 wt. % to less than or equal to about 90 wt. %, of a first solvent. The additional solvent may be selected from the group consisting of: dimethyl carbonate (DMC), ethyl acetate, acetonitrile, ethyl methyl carbonate and combinations thereof. The additional solvent has a first evaporating temperature that is less than a second evaporating temperature of the first solvent.

Loading 250 the free-standing porous film with a gel polymer electrolyte may further include removing 252 the additional solvent to form the electrolyte layer. In certain variations, the additional solvent may be removed using a heating process. For example, the free-standing porous film with the gel polymer electrolyte may be moved through an oven having a controlled temperature.

Certain features of the current technology are further illustrated in the following non-limiting examples.

### EXAMPLE 1

Example battery cells may be prepared in accordance with various aspects of the present disclosure.

For example, an example electrolyte layer 310 may include a porous film defined by a plurality of solid-state electrolyte particles and fibrillated polymers, and a gel polymer electrolyte that at least partially fills voids or pores and grain boundaries in the porous film. A comparative solid-state electrolyte layer 320 may include the plurality of solid-state electrolyte particles, but omits the fibrillated polymers and gel polymer electrolyte.

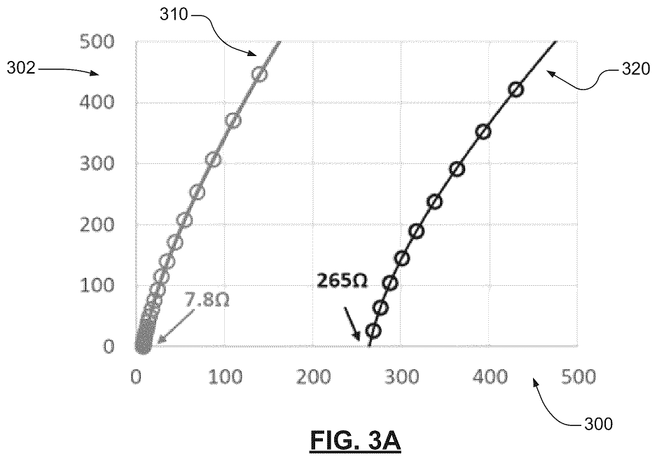

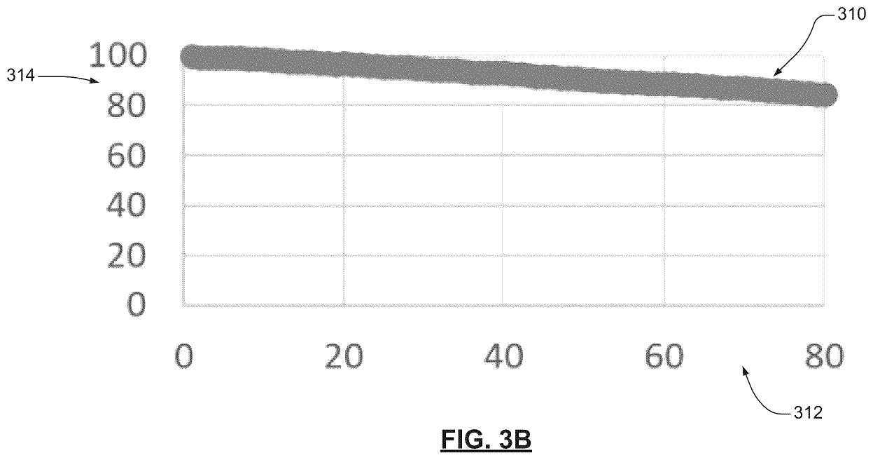

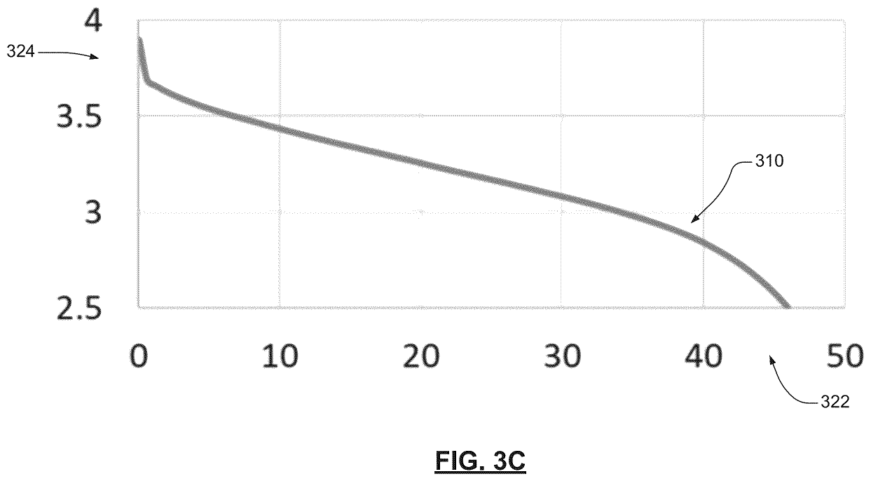

FIG. 3A is a graphical illustration demonstrating the impedance of the example electrolyte layer 310 as compared to the comparative solid-state electrolyte layer 320, where the x-axis 302 represents real impedance (Ohms), and the y-axis 304 represents imaginary impedance (Ohms). As illustrated, the example electrolyte layer 310 has a much lower resistance as compared to the comparative solids-state electrolyte layer 320.

FIG. 3B is a graphical illustration demonstrating the capacity retention at room temperature of the example electrolyte layer 310 as compared to the comparative solid-state electrolyte layer 320, where the x-axis 312 represents cycle number, and the y-axis 314 represents capacity retention (%). As illustrated, the example electrolyte layer 310 has good cycling performance at room temperature at 1C rate.

FIG. 3C is a graphical illustration demonstrating area conductance (ohms/cm²) at ˜18° C. of an example electrolyte layer 310 as compared to the comparative solid-state electrolyte layer 320, where the x-axis 322 represents capacity retention (%), and the y-axis 324 represents voltage (V). As illustrated, the example electrolyte layer 310 has good low temperature performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrolyte layer for use in an electrochemical cell that cycles lithium ions, the electrolyte layer comprising:
a porous film defining a plurality of voids and comprising a plurality of solid-state electrolyte particles and a plurality of polymeric fibrils that connect the solid-state electrolyte particles; and
a gel polymeric electrolyte at least partially filling the plurality of voids in the porous film.

2. The electrolyte layer of claim 1, wherein the solid-state electrolyte particles have an ionic conductivity greater than or equal to about 0.1 mS/cm to less than or equal to about 20 mS/cm at greater than or equal to about 20° C. to less than or equal to about 22° C., wherein the plurality of solid-state electrolyte particles is selected from the group consisting of: oxide-based solid-state particles, metal-doped or aliovalent-substituted oxide solid-state particles, halide-based solid-state particles, hydride-based solid-state particles, and combinations thereof.

3. The electrolyte layer of claim 2, wherein the plurality of solid-state electrolyte particles comprises oxide-based solid-state particles.

4. The electrolyte layer of claim 1, wherein the polymeric fibrils are selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

5. The electrolyte layer of claim 4, wherein the polytetrafluorethylene (PTFE) fibrils have a softening point of greater than or equal to about 260° C. to less than or equal to about 327° C.,
the fluorinated ethylene propylene (FEP) fibrils have a softening point greater than or equal to about 204° C. to less than or equal to about 260° C., and
the ethylene tetrafluoroethylene (ETFE) fibrils have a softening point greater than or equal to about 260° C. to less than or equal to about 315° C.

6. The electrolyte layer of claim 1, wherein each of the polymeric fibrils having a fiber length greater than or equal to about 2 micrometers to less than or equal to about 100 micrometers and a molecular weight greater than or equal to about 10⁵ g/mol to less than or equal to about 10⁹ g/mol.

7. The electrolyte layer of claim 1, wherein the gel polymeric electrolyte comprises:
greater than or equal to about 0.1 wt. % to less than or equal to about 50 wt. % of a polymer host; and
greater than or equal to about 5 wt. % to less than or equal to about 90 wt. % of a liquid electrolyte.

8. The electrolyte layer of claim 7, wherein the polymer host is selected from the group consisting of: polyethylene oxide (PEO), polyvinylidene fluoride-hexafluoropropylene (PVDF-HFP), polymethyl methacrylate (PMMA), carboxymethyl cellulose (CMC), polyacrylonitrile (PAN), polyvinylpyrrolidone (PVP), and combinations thereof.

9. The electrolyte layer of claim 1, wherein the porous film has a porosity greater than or equal to about 10 vol. % to less than or equal to about 50 vol. %, and the gel polymer electrolyte fills greater than or equal to about 0.1% to less than or equal to about 150% of a total porosity defined by the plurality of voids of the porous film.

10. The electrolyte layer of claim 1, wherein the porous film comprises greater than or equal to about 70 wt. % to less than or equal to about 99 wt. % of the plurality of solid-state electrolyte particles,
greater than or equal to about 0.1 wt. % to less than or equal to about 10 wt. % of the plurality of polymeric fibrils, and
greater than or equal to about 0.1 wt. % to less than or equal to about 20 wt. % of the gel polymeric electrolyte.

11. The electrolyte layer of claim 1, wherein the electrolyte layer has an average thickness greater than or equal to about 2 micrometers to less than or equal to about 100 micrometers.

12. An electrochemical cell that cycles lithium ions, the electrochemical cell comprising:
a first electrode;
a second electrode; and
an electrolyte layer disposed between the first electrode and the second electrode, the electrolyte layer comprising:
a plurality of solid-state electrolyte particles;
a plurality of polymeric fibrils that connect the solid-state electrolyte particles; and
a gel polymeric electrolyte that at least partially fills voids defined between the solid-state electrolyte particles and the polymeric fibrils.

13. The electrochemical cell of claim 12, wherein the plurality of solid-state electrolyte particles have an ionic conductivity greater than or equal to about 0.1 mS/cm to less than or equal to about 20 mS/cm at greater than or equal to about 20° C. to less than or equal to about 22° C. and the plurality of solid-state electrolyte particles is selected from the group consisting of: oxide-based solid-state particles, metal-doped or aliovalent-substituted oxide solid-state particles, halide-based solid-state particles, hydride-based solid-state particles, and combinations thereof.

14. The electrochemical cell of claim 12, wherein each of the polymeric fibrils has a fiber length greater than or equal to about 2 micrometers to less than or equal to about 100 micrometers and a molecular weight greater than or equal to about 10⁵ g/mol to less than or equal to about 10⁹ g/mol, and the polymeric fibrils are selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

15. The electrochemical cell of claim 12, wherein the gel polymeric electrolyte comprises:
greater than or equal to about 0.1 wt. % to less than or equal to about 50 wt. % of a polymer host; and
greater than or equal to about 5 wt. % to less than or equal to about 90 wt. % of a liquid electrolyte.

16. The electrochemical cell of claim 12, wherein the plurality of solid-state electrolyte particles and the plurality of polymeric fibrils that connect the solid-state electrolyte particles define a porous film defining a plurality of voids, the porous film having a porosity greater than or equal to about 10 vol. % to less than or equal to about 50 vol. %, and the gel polymeric electrolyte filling greater than or equal to about 0.1% to less than or equal to about 150% of the plurality of voids in the porous film.

17. The electrochemical cell of claim 12, wherein the electrolyte layer has a thickness greater than or equal to about 2 micrometers to less than or equal to about 100 micrometers.

18. An electrolyte layer for use in an electrochemical cell that cycles lithium ions, the electrolyte layer comprising:
a porous film defined by a plurality of oxide-based solid-state particles and a plurality of polymeric fibrils that connect the solid-state electrolyte particles, the porous film having a thickness greater than or equal to about 2 micrometers to less than or equal to about 100 micrometers, and a porosity greater than or equal to about 10 vol. % to less than or equal to about 50 vol. %; and
a gel polymeric electrolyte filling greater than or equal to about 0.1% to less than or equal to about 150% of a total porosity of the porous film.

19. The electrolyte layer of claim 18, wherein each of the polymeric fibrils has a fiber length greater than or equal to about 2 micrometers to less than or equal to about 100 micrometers, and the polymeric fibrils are selected from the group consisting of: polytetrafluorethylene (PTFE) fibrils, fluorinated ethylene propylene (FEP) fibrils, perfluoroalkoxy alkane (PFA) fibrils, ethylene tetrafluoroethylene (ETFE) fibrils, and combinations thereof.

20. The electrolyte layer of claim 18, wherein the gel polymeric electrolyte comprises:
greater than or equal to about 0.1 wt. % to less than or equal to about 50 wt. % of a polymer host; and
greater than or equal to about 5 wt. % to less than or equal to about 90 wt. % of a liquid electrolyte.
